(19) United States
(12) Patent Application Publication
(10) Pub. No.: US 2003/0046703 A1
(43) Pub. Date: Mar. 6, 2003

(54) Systems and methods for facilitating user access to content stored on private networks

(76) Inventors: Gregory T. Knowles, Raleigh, NC (US); Brian T. Webb, Raleigh, NC (US); Bradley T. Marchesseault, Cary, NC (US); L. Joseph Bartolanzo, Durham, NC (US); Gary D. Deen, Durham, NC (US)

Correspondence Address: Wagner Murabito & Hao LLP, Two North Market Street, Thrid Floor, San Jose, CA, 95113, US

(21) Appl. No.: 09/942,469

(22) Filed: Aug. 29, 2001

(51) Int. Cl. H04N 7/173

(52) U.S. Cl. 725/92; 725/91; 709/219

(57) ABSTRACT

Systems and methods that facilitate user access to various types of content stored within one or more devices on a private network, both from other devices on the private network and from devices external to the private network, are provided. Content stored within each network device is published to the private network (e.g., to other devices on the private network), either periodically or continuously, via a respective contributor module associated with each network device. Meta information about content stored within each network device (and/or content) is aggregated, either periodically or continuously, via an aggregator module in communication with each contributor module. The content stored within the network devices (or content centrally stored) is then categorized, either automatically or manually by a user, into one or more content categories via a categorizer module in communication with the aggregator module. A user can formulate and send queries for content to the aggregator module via a user interface, such as an audio player, video player, image viewer, etc. Query results are returned to the requesting user interface from the aggregator module and displayed. Content selected from the displayed query results by a user is then retrieved from wherever it is stored on the private network.

### FIELD OF THE INVENTION

The present invention relates generally to computer networks and, more particularly, to systems and methods for storing and retrieving resources on computer networks.

### BACKGROUND OF THE INVENTION

Increasingly, people are gathering large amounts of digital media content (hereinafter “content”), including music files, image files, video files, etc. For example, music files in formats such as MP3 are increasingly available for download via the Internet. Audio players such as Winamp allow users to store, retrieve and play MP3 files. Various other audio players are available for audio files of different formats. Similarly, the use of digital cameras has increased dramatically and many users are storing video files and images taken via their digital cameras on their personal computers. Video players and image viewers are available that allow users to store, retrieve and display video and image files of various formats.

Unfortunately, storing, organizing, and using digital media content, particularly when large numbers of media content files exist, can be difficult. Accordingly, there is a need for improved ways of storing, organizing, and using digital media content.

Increasingly, existing homes and homes under construction are being “networked” wherein communications cables (video, data, and/or telecommunications cables) are being extended to many rooms and, in some cases, to multiple locations within each room. Currently, devices are networked in the home via technologies such as, Ethernet, wireless, phone-line networking, and power-line networking. Phone-line networking allows PCs and other devices to be networked by plugging them into phone jacks, while power-line networking allows PCs and other devices to communicate through electrical outlets. One benefit of “home networking” includes the ability to network multiple computers and share multimedia content throughout the home. For example, using an audio player like Winamp on a device, a user can play an MP3 file located on another device connected to a home network.

Unfortunately, conventional home networks and other private networks may not allow users to remotely access and play content stored within devices connected thereto. For example, conventional home networks may not allow users to launch Winamp on devices external to the home network and play MP3 files stored on devices connected to a home network. Accordingly, there is a need for facilitating remote user access to content stored on machines connected to a private network, such as a home network.

### SUMMARY OF THE INVENTION

In view of the above discussion, systems and methods that facilitate user access to various types of content stored within one or more devices on a private network, both from other devices on the private network and from devices external to the private network, are provided. Content, such as audio files, video files, image files, etc. may be stored within various types of devices connected to the private network (e.g., personal computers, laptop computers, personal digital assistants, etc.). Content stored within each network device is published to the private network (e.g., to other devices on the private network), either periodically or continuously, via a respective contributor module associated with each network device. Content publishing includes monitoring content stored within a network device and announcing the presence of content stored within a network device to other network devices via a salutation/discovery protocol.

Meta information about content stored within each network device is aggregated, either periodically or continuously, via an aggregator module in communication with each contributor module. The content stored within the network devices is then categorized, either automatically or manually by a user, into one or more content categories via a categorizer module in communication with the aggregator module.

The content stored within the various network devices can be presented to users via one or more user interfaces, such as audio players, video players, image viewers, etc. A user formulates and sends a query for content to the aggregator module via a user interface. The results of the query to the aggregator module are returned to the requesting user interface from the aggregator module and displayed. Content selected from the displayed query results by a user is then retrieved from wherever it is stored on the private network. Prior to delivery to a requesting user, content may be tailored and/or reformatted to be compatible with a requesting user interface by one or more contributor modules.

The type of category into which content is arranged is dependent on the given content format. For example, audio and video content may be arranged into “channels” of content, such that a user can request delivery of a channel of content in lieu of individual content files.

According to embodiments of the present invention, a gateway may be provided on a private network that allows users to securely access content (e.g., individual files and/or “channels” of content) from outside the private network. The gateway has an IP address that is valid on the Internet and permits communications between selected external devices and devices on the private network.

### BRIEF DESCRIPTION OF THE DRAWINGS

FIG. 1 is a block diagram of a content management system according to embodiments of the present invention.

FIG. 2 is a block diagram of a content management system according to additional embodiments of the present invention.

FIGS. 3-5 are flowchart illustrations of methods, apparatus (systems) and computer program products, according to embodiments of the invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout the description of the drawings.

As will be appreciated by one of skill in the art, the present invention may be embodied as methods and data processing systems. Accordingly, the present invention may take the form of an entirely hardware embodiment, an entirely software embodiment or an embodiment combining software and hardware aspects.

Computer program code for carrying out operations of the various modules of the present invention may be written in an object oriented programming language such as JAVA®, Smalltalk or C++. Computer program code for carrying out operations of the various modules of the present invention may also be written in conventional procedural programming languages, such as “C”, or in various other programming languages. Software embodiments of the present invention do not depend on implementation with a particular programming language. In addition, portions of computer program code may execute entirely on one or more data processing systems.

The present invention is described below with reference to block diagram and flowchart illustrations of methods and systems according to embodiments of the present invention. It is understood that each block of the block diagram and flowchart illustrations, and combinations of blocks in the block diagram and flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagram and flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagram and flowchart block or blocks.

It should be noted that, in some alternative embodiments of the present invention, the functions noted in the flowchart blocks may occur out of the order noted in the flowcharts. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

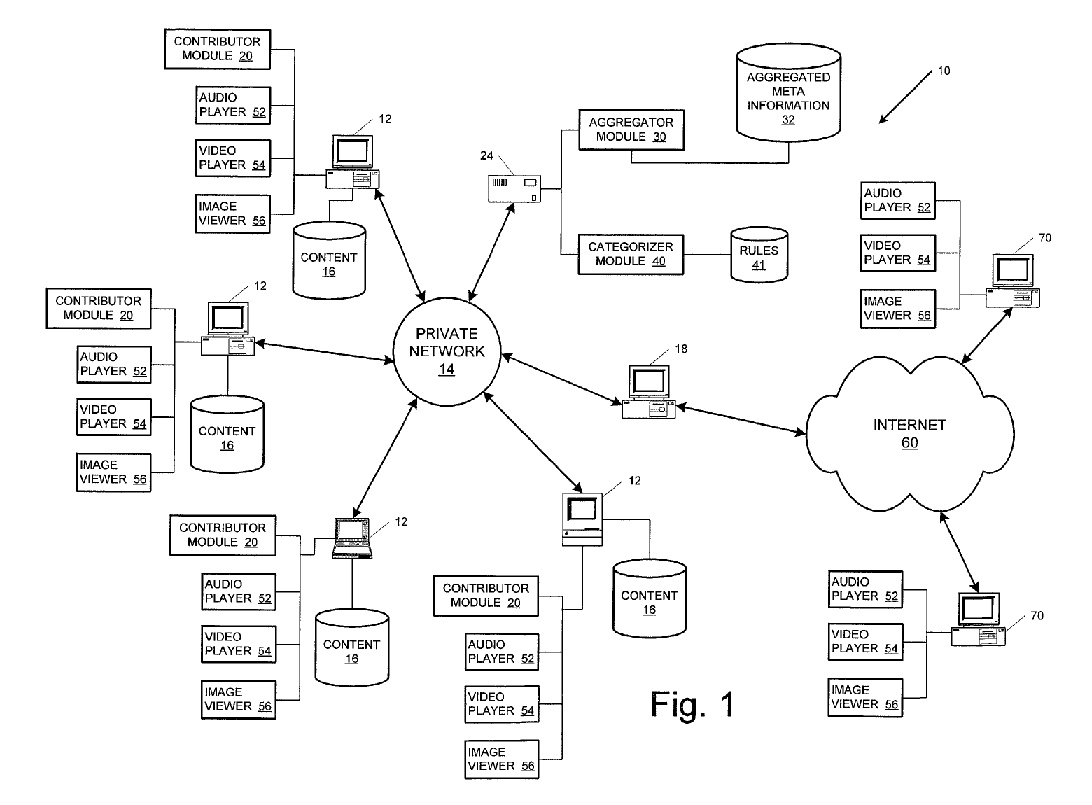

FIG. 1 is a schematic diagram of a content management system 10 according to embodiments of the present invention. A plurality of devices 12 (e.g., personal computers, laptop computers, personal digital assistants, etc.) are connected to a private network 14 (e.g., a home network, an enterprise network, etc.) and have various types of content stored in local storage 16. The network devices 12 may be connected to the private network 14 via various technologies including, but not limited to, Ethernet, wireless, phone-line networking, and/or power-line networking. The illustrated private network 14 is isolated from the Internet 60 by a gateway 18.

Each network device 12 in the illustrated content management system 10 includes software executing thereon referred to as a contributor module 20 that is configured to monitor local data storage of the respective network device 12 for various types of content and to “publish” or announce the presence of locally stored content, as well as changes to content, to other network devices 12 via a salutation/discovery protocol. Each contributor module 20 may be configured to continuously or periodically scan the local data storage of a respective network device. According to embodiments of the present invention, users can restrict the types of files and/or the directories/sub-directories of files that can be monitored and published. For example, a user may not want certain types of files published such as temporary files. A user may not want files within directories such as “temporary internet files” or “cache” published.

For example, when a user downloads an MP3 file from the Internet and stores the file locally on a network device 12, the contributor module 20 for the respective network device 12 detects the new file and publishes the existence of the new file to the other network devices 12. Exemplary salutation/discovery protocols that may be utilized to publish content in accordance with embodiments of the present invention include Universal Plug and Play (UPnP; www.upnp.org), Jini™ (www.jini.org), Salutation (www.salutation.org), etc. When content is stored within a network device, a salutation/discovery protocol (e.g., UPnP, Jini™, Salutation, etc.) allows the contributor module to announce the presence of the content to other devices on the network, along with information about the content (e.g., meta information). UPnP, Jini™, and Salutation are well known to those skilled in this art and need not be discussed further herein.

As used herein, the term “content” means any type of resource available for storage and retrieval via a computer including, but not limited to, audio content (e.g., MP3 format files, AVI format files, WAV format files, WMA format files, streaming audio, etc.); video content (e.g., MPG format files, QuickTime format files, streaming video, etc.); image content (e.g., JPEG format files, GIF format files, TIFF format files, etc.); electronic books (e.g., “eBooks”); text files, etc. Each contributor module 20 may be configured to scan and detect one or more types of content.

The illustrated content management system 10 also includes a network device 24 having software executing thereon referred to as an aggregator module 30 that is configured to obtain and store content meta information (i.e., descriptive information about content) from each contributor module 20 about content stored within each respective network device 12. The aggregator module 30 stores content meta information within one or more databases, indicated as 32. The aggregator module 30 may monitor each contributor module 20 on a continuous or periodic basis.

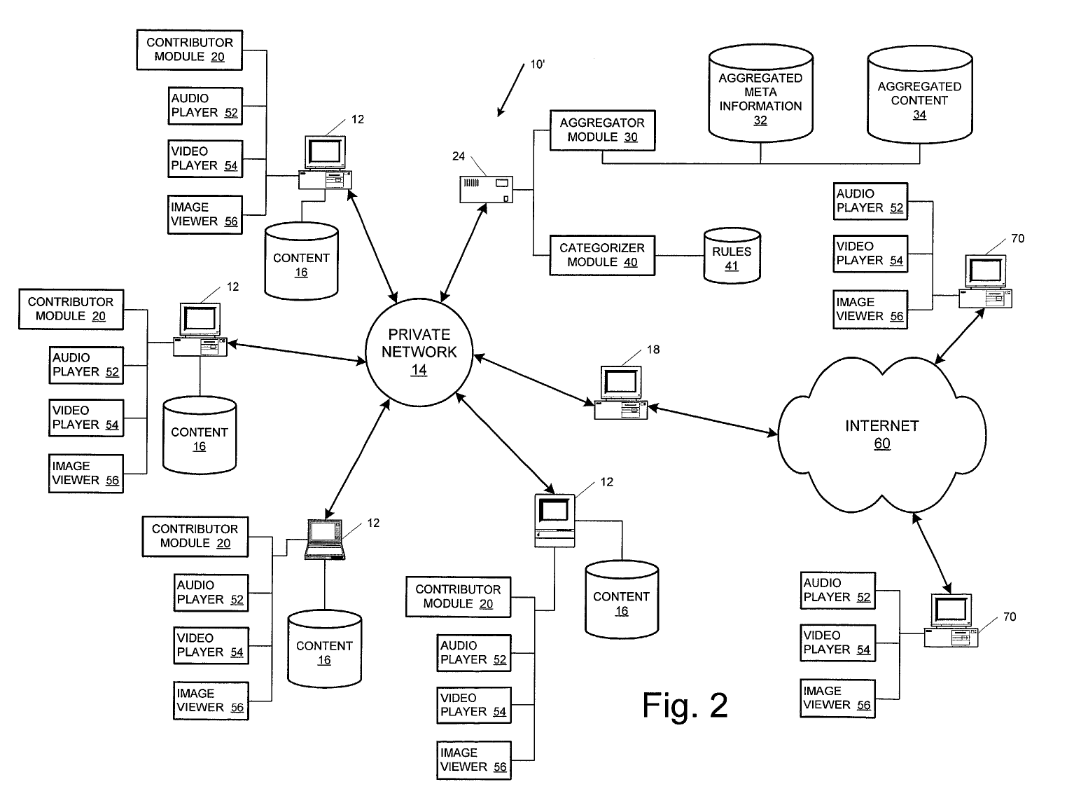

In the illustrated embodiment of FIG. 1, content is stored locally on the various network devices 12 and only content meta information is aggregated and stored by the aggregator module 30. A content management system 10′ according to an alternative embodiment of the present invention is illustrated in FIG. 2 and includes an aggregator module 30 that is configured to aggregate and store both content and content meta information. In FIG. 2, content stored by the aggregator module 30 is stored in one or more databases, indicated as 34.

The illustrated network device 24 in FIGS. 1-2 also includes software executing thereon referred to as a categorizer module 40 that is configured to communicate with the aggregator module 30 and to use content meta information stored by the aggregator module 30 to arrange the content stored within the network devices into one or more content categories based upon the content itself, and/or based upon stored rules 41 for the user. The type of category into which content is arranged is dependent on the given content format and upon stored rules (e.g., user identification, preferences, etc.). For example, there may be thousands of music files (e.g., MP3 files) stored in the various network devices 12 for which the aggregator module 30 has obtained and stored meta information therefor. The categorizer module 40 can utilize the meta information for these MP3 files to create one or more music channels. For example, the categorizer module may be able to categorize all jazz MP3 files into a “jazz channel” thereby allowing a user to specify via a user interface that he/she wishes to listen to “jazz.” Rules 41 upon which files are categorized automatically may be updated and/or changed by users, according to embodiments of the present invention.

Content may be arranged into categories automatically via the categorizer module 40 or a user may utilize the categorizer module 40 to individually arrange content into categories, such as channels. For example, a conventional MP3 file includes meta information in the last thirty characters (referred to as ID3 field) of the file. The ID3 field typically includes meta information such as music “genre”. Accordingly, music files falling in the jazz genre may be so identified via the ID3 field. The categorizer module 40 can be configured to automatically parse an MP3 file and detect various information from the ID3 field. Alternatively, a user can manually specify to the categorizer module 40 how a particular content file is to be categorized. Certain types of content may not allow automatic categorization via the categorizer module 40. For example, image files may not contain meta information that a categorizer module can utilize. However, various algorithms may be utilized to categorize content. For example, advanced image analysis techniques may be employed to categorize image files.

The aggregator and categorizer modules 30, 40 may be combined or may be separately executing programs. In addition, the aggregator and categorizer modules 30, 40 may execute on the same or different network devices.

In the illustrated content management system 10 of FIGS. 1-2, each network device 12 includes an audio player 52, a video player 54, and an image viewer 56, which serve as respective user interfaces associated with respective types of content. Audio players, video players, and image viewers are well known to those skilled in this art and need not be described further herein.

Each user interface (i.e., the audio player 52, video player 54, or image viewer 56) can find the aggregator module 30 via a salutation protocol for content available on the private network 14 in response to a user request, and to display the results of such queries. In addition, each user interface is also configured to retrieve and present content from one or more network devices 12 in response to user selection of displayed query results. According to embodiments of the present invention, a user interface can serve the function of an aggregator module 30.

For example, a user may open an audio player 52 on a network device 12 and send a query for a listing of all jazz audio files on the network. The audio player 52 sends the query to the aggregator module 30 which searches the stored aggregated meta information 32 and returns a listing of content that satisfies the query. The user can select one or more files from the displayed results and the selected content is retrieved by the audio player 52 from where it is stored on the network 14 and played to the user. If the particular music file is stored by the aggregator module 30, the audio player 52 retrieves the music file from the aggregated content database 34 (FIG. 2).

A user may also make a request to the aggregator module 30, via an audio player 52, to retrieve and play a channel of content. For example, a user may instruct an audio player 52 to retrieve and play audio content from the various network devices 12 in response to user selection of a channel created by the categorizer module 40.

Embodiments of the present invention are not limited to the illustrated configurations of FIGS. 1-2. Various types and numbers of network devices may be utilized. Moreover, network devices may be configured differently. For example, one network device may include an audio player, but not a video player. Another network device may include only an image viewer, etc.

According to additional embodiments of the present invention, a contributor module 20 associated with a network device 12 may be configured to tailor content requested by a user prior to retrieval by a user interface. The capabilities of various user interfaces to receive, process, and display content may vary. For example, if an image file having a size of 1600×1200 pixels is requested by an image viewer that can only display 320×240 pixels, the requested image may not be displayed properly, if at all, unless the size of the image is tailored from 1600×1200 pixels to 320×240 pixels. Furthermore, some user interfaces may require content to be in a certain format. For example, an image viewer may not be capable of displaying certain image file types such as JPEG or GIF. Accordingly, a contributor module 20 according to embodiments of the present invention may be configured to change the format (e.g., change an image format from GIF to JPEG) of requested content to suit a requesting user interface prior to retrieval by the user interface.

According to embodiments of the present invention, a contributor module 20 may be configured to tailor and/or reformat content as necessary including, but not limited to, audio content, video content, images, text, etc. Content tailoring and reformatting is understood by those skilled in the art and need not be described further herein.

Embodiments of the present invention may be specifically designed for a particular type of content, such as audio content. For example, according to embodiments of the present invention, an audio content management system that facilitates user access to personal audio content stored on one or more private network devices includes one or more contributor modules associated with respective private network devices, wherein each contributor module continuously monitors audio content stored within a respective network device and announces the presence of the audio content to other network devices. The audio content management system includes an aggregator module that continuously monitors each contributor module and that obtains and stores meta information from each contributor module about audio content stored within each respective network device, as well as changes to audio content stored within each respective network device. In addition, the audio content management module includes a categorizer module that uses meta information stored by the aggregator module to arrange the audio content stored within the network devices into one or more audio channels. An audio player in communication with the private network (e.g., executing on a network device) is configured to retrieve and play audio content from the network devices in response to user selection of a channel. A gateway connected to the private network may be provided and is configured to grant access to audio content stored within the network devices to authorized users via devices not connected to the network.

Similarly, according to embodiments of the present invention, a video content management system that facilitates user access to personal video content stored on one or more private network devices includes one or more contributor modules associated with respective private network devices, wherein each contributor module continuously monitors video content stored within a respective network device and announces the presence of the video content to other network devices. The video content management system includes an aggregator module that continuously monitors each contributor module and that obtains and stores meta information from each contributor module about video content stored within each respective network device, as well as changes to video content stored within each respective network device. In addition, the video content management module includes a categorizer module that uses meta information stored by the aggregator module to arrange the video content stored within the network devices into one or more video channels. A video player in communication with the private network (e.g., executing on a network device) is configured to retrieve and play video content from the network devices in response to user selection of a channel. A gateway connected to the private network may be provided and is configured to grant access to video content stored within the network devices to authorized users via devices not connected to the network.

According to embodiments of the present invention, a gateway 18 may be provided on a private network 14 that allows users to securely access content (e.g., individual files and/or “channels” of content) from outside the private network 14. The gateway 18 has an IP address that is valid on the Internet 60 and permits communications between selected external devices 70 and devices 12 on the private network 14. A particularly preferred gateway for use in accordance with embodiments of the present invention is described in co-pending, co-assigned U.S. patent application, Ser. No. 09/874,802, filed Jun. 5, 2001, which is incorporated herein by reference in its entirety.

Preferably, communications between external devices and devices on a private network utilize a secure transmission scheme, such as Secure Sockets Layer (SSL). SSL is a commonly-used protocol for managing the security of a message transmission on the Internet, and is well known to those of skill in the art. A gateway according to embodiments of the present invention may be configured to communicate with various types of external devices such as conventional PC devices, as well as conventional portable devices, such as PDAs, handheld computers, and/or Web-enabled phones. A gateway 18 according to embodiments of the present invention may include various security features, such as firewalls to prevent strangers from hacking into a home network, as well as virus protection. OSGi (Open Service Gateway Initiative) is an exemplary residential gateway standard that may be utilized by a gateway 18.

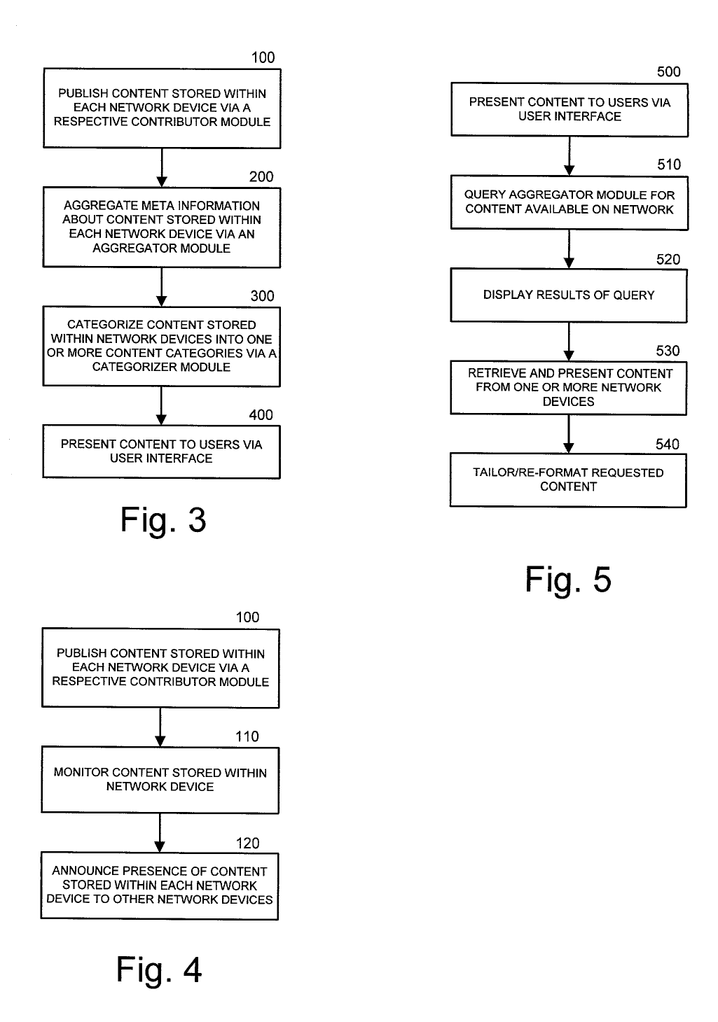

FIGS. 3-5 are flowchart illustrations of methods, apparatus (systems) and computer program products, according to embodiments of the invention, that facilitate user access to content stored within one or more devices on a private network. Referring initially to FIG. 3, content stored within each network device is published to the private network (e.g., to other devices on the private network), either periodically or continuously, via a respective contributor module associated with each network device (Block 100). Content publishing includes monitoring content stored within a network device (Block 110, FIG. 4) and announcing the presence of content stored within a network device to other network devices (Block 120, FIG. 4).

Meta information about content stored within each network device is aggregated, either periodically or continuously, via an aggregator module in communication with each contributor module (Block 200). The content stored within the network devices is then categorized, either automatically or manually by a user, into one or more content categories via a categorizer module in communication with the aggregator module (Block 300). The content stored within the various network devices can be presented to users via one or more user interfaces, such as audio players, video players, image viewers, etc. (Block 400).

Referring to FIG. 5, operations associated with presenting stored content to users via a user interface include sending a query for content available on the private network to the aggregator module via a user interface (e.g., an audio player, video player, image viewer, etc.) (Block 510). The results of a query to the aggregator module are returned to the requesting user interface from the aggregator module and displayed (Block 520). Content selected from the displayed query results by a user is then retrieved from wherever it is stored on the private network (Block 530). Prior to delivery to a requesting user, content may be tailored and/or reformatted to be compatible with a requesting user interface by one or more contributor modules (Block 540).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A content management system that facilitates user access to content stored within a plurality of network devices, comprising:
a contributor module associated with each respective network device, wherein each contributor module monitors content stored within a respective network device and announces the presence of the content to other network devices;
an aggregator module in communication with the network, wherein the aggregator module obtains and stores meta information from each contributor module about content stored within each respective network device; and
a user interface in communication with the network, wherein the user interface is associated with a respective type of content, wherein the user interface, in response to a user request, queries the aggregator module for content available on the network, displays results of the query, and, in response to user selection of displayed results, retrieves and presents content from one or more network devices.

2. The content management system of claim 1, wherein the contributor module monitors content stored within a respective network device and announces the presence of content stored within the respective network device to other network devices substantially continuously.

3. The content management system of claim 1, wherein the aggregator module obtains and stores meta information from each contributor module substantially continuously.

4. The content management system of claim 1, further comprising a categorizer module in communication with the aggregator module, wherein the categorizer module uses information stored by the aggregator module to arrange the content stored within the network devices into one or more content categories, and wherein the user interface retrieves content from the network devices and presents the retrieved content to users in response to user selection of a content category.

5. The content management system of claim 1, wherein the aggregator module monitors each contributor module for changes in content stored in each respective network device, and updates stored meta information to reflect changes in content stored within a respective network device.

6. The content management system of claim 1, wherein each contributor module is configured to tailor requested content prior to retrieval by the user interface.

7. The content management system of claim 1, wherein each contributor module is configured to change a format of requested content from a first format to a second format different from the first format prior to retrieval by the user interface.

8. The content management system of claim 1, wherein the aggregator module is configured to retrieve content from the network devices and store the retrieved content, and wherein the user interface is configured to retrieve content from the aggregator module and present the retrieved content to user selection.

9. The content management system of claim 1, further comprisig a gateway connected to the network that grants access to content stored within the network devices to authorized users via devices not connected to the network.

10. The content management system of claim 1, wherein the content comprises audio content, and wherein the user interface comprises an audio player.

11. The content management system of claim 1, wherein the content comprises video content, and wherein the user interface comprises a video player.

12. The content management system of claim 1, wherein the content comprises image content, and wherein the user interface comprises an image viewer.

13. A content management system that facilitates user access to content stored within a plurality of network devices, comprising:
a contributor module associated with each respective network device, wherein each contributor module continuously monitors content stored within a respective network device and continuously announces the presence of the content to other network devices;
an aggregator module in communication with the network, wherein the aggregator module continuously obtains and stores meta information from each contributor module about content stored within each respective network device;
a categorizer module in communication with the aggregator module, wherein the categorizer module uses information stored by the aggregator module to arrange the content stored within the network devices into one or more content categories; and
a user interface in communication with the network, wherein the user interface is associated with a respective type of content, wherein the user interface, in response to a user request, queries the aggregator module for content categories available on the network, displays results of the query, and, in response to user selection of a category, retrieves and presents content from one or more network devices.

14. The content management system of claim 13, wherein the aggregator module monitors each contributor module for changes in content stored in each respective network device, and updates stored meta information to reflect changes in content stored within a respective network device.

15. The content management system of claim 13, wherein each contributor module is configured to tailor requested content prior to retrieval by the user interface.

16. The content management system of claim 13, wherein each contributor module is configured to change a format of requested content from a first format to a second format different from the first format prior to retrieval by the user interface.

17. The content management system of claim 13, wherein the aggregator module is configured to retrieve content from the network devices and store the retrieved content, and wherein the user interface is configured to retrieve content from the aggregator module and present the retrieved content to user selection.

18. The content management system of claim 13, further comprising a gateway connected to the network that grants access to content stored within the network devices to authorized users via devices not connected to the network.

19. The content management system of claim 13, wherein the content comprises audio content, and wherein the user interface comprises an audio player.

20. The content management system of claim 13, wherein the content comprises video content, and wherein the user interface comprises a video player.

21. The content management system of claim 13, wherein the content comprises image content, and wherein the user interface comprises an image viewer.

22. An audio content management system that facilitates user access to audio content stored within a plurality of network devices, comprising:
a contributor module associated with each respective network device, wherein each contributor module monitors audio content stored within a respective network device and announces the presence of the audio content to other network devices;
an aggregator module in communication with the network, wherein the aggregator module obtains and stores meta information from each contributor module about audio content stored within each respective network device;
a categorizer module in communication with the aggregator module, wherein the categorizer module uses meta information stored by the aggregator module to arrange the audio content stored within the network devices into one or more audio channels; and
a user interface in communication with the network, wherein the user interface comprises an audio player that retrieves and plays audio content from the network devices in response to user selection of a channel.

23. The audio content management system of claim 22, wherein the contributor module monitors audio content stored within a respective network device and announces the presence of audio content stored within the respective network device to other network devices substantially continuously.

24. The audio content management system of claim 22, wherein the aggregator module obtains and stores meta information from each contributor module substantially continuously.

25. The audio content management system of claim 22, wherein the aggregator module monitors each contributor module for changes in audio content stored in each respective network device, and updates stored meta information to reflect changes in audio content stored within a respective network device.

26. The audio content management system of claim 22, wherein each contributor module is configured to tailor audio content prior to retrieval by the user interface.

27. The audio content management system of claim 22, wherein each contributor module is configured to change a format of audio content from a first format to a second format different from the first format prior to retrieval by the user interface.

28. The audio content management system of claim 22, wherein the aggregator module is configured to retrieve audio content from the network devices and store the retrieved audio content, and wherein the user interface is configured to retrieve audio content from the aggregator module and present the retrieved audio content to user selection.

29. The audio content management system of claim 22, further comprising a gateway connected to the network that grants access to audio content stored within the network devices to authorized users via devices not connected to the network.

30. A video content management system that facilitates user access to video content stored within a plurality of network devices, comprising:
a contributor module associated with each respective network device, wherein each contributor module monitors video content stored within a respective network device and announces the presence of the video content to other network devices;
an aggregator module in communication with the network, wherein the aggregator module obtains and stores meta information from each contributor module about video content stored within each respective network device;
a categorizer module in communication with the aggregator module, wherein the categorizer module uses meta information stored by the aggregator module to arrange the video content stored within the network devices into one or more video channels; and
a user interface in communication with the network, wherein the user interface comprises a video player that retrieves and plays video content from the network devices in response to user selection of a channel.

31. The video content management system of claim 30, wherein the contributor module monitors video content stored within a respective network device and announces the presence of video content stored within the respective network device to other network devices substantially continuously.

32. The video content management system of claim 30, wherein the aggregator module obtains and stores meta information from each contributor module substantially continuously.

33. The video content management system of claim 30, wherein the aggregator module monitors each contributor module for changes in video content stored in each respective network device, and updates stored meta information to reflect changes in video content stored within a respective network device.

34. The video content management system of claim 30, wherein each contributor module is configured to tailor video content prior to retrieval by the user interface.

35. The video content management system of claim 30, wherein each contributor module is configured to change a format of video content from a first format to a second format different from the first format prior to retrieval by the user interface.

36. The video content management system of claim 30, wherein the aggregator module is configured to retrieve video content from the network devices and store the retrieved video content, and wherein the user interface is configured to retrieve video content from the aggregator module and present the retrieved video content to user selection.

37. The video content management system of claim 30, further comprising a gateway connected to the network that grants access to video content stored within the network devices to authorized users via devices not connected to the network.

38. A content management system that facilitates user access to content stored within a plurality of network devices, comprising:
a contributor module associated with each respective network device, wherein each contributor module monitors content stored within a respective network device and announces the presence of the content to other network devices;
an aggregator module in communication with the network, wherein the aggregator module obtains and stores meta information from each contributor module about content stored within each respective network device;
a categorizer module in communication with the aggregator module, wherein the categorizer module uses information stored by the aggregator module to arrange the content stored within the network devices into one or more content categories;
a user interface in communication with the network, wherein the user interface is associated with a respective type of content, wherein the user interface, in response to a user request, queries the aggregator module for content categories available on the network, displays results of the query, and, in response to user selection of a category, retrieves and presents content from one or more network devices; and
a gateway connected to the network that grants access to content stored within the network devices to authorized users via devices not connected to the network.

39. The content management system of claim 38, wherein the contributor module monitors content stored within a respective network device and announces the presence of content stored within the respective network device to other network devices substantially continuously.

40. The content management system of claim 38, wherein the aggregator module obtains and stores meta information from each contributor module substantially continuously.

41. The content management system of claim 38, wherein the aggregator module monitors each contributor module for changes in content stored in each respective network device, and updates stored meta information to reflect changes in content stored within a respective network device.

42. The content management system of claim 38, wherein each contributor module is configured to tailor requested content prior to retrieval by the user interface.

43. The content management system of claim 38, wherein each contributor module is configured to change a format of requested content from a first format to a second format different from the first format prior to retrieval by the user interface.

44. The content management system of claim 38, wherein the aggregator module is configured to retrieve content from the network devices and store the retrieved content, and wherein the user interface is configured to retrieve content from the aggregator module and present the retrieved content to user selection.

45. The content management system of claim 38, wherein the content comprises audio content, and wherein the user interface comprises an audio player.

46. The content management system of claim 38, wherein the content comprises video content, and wherein the user interface comprises a video player.

47. The content management system of claim 38, wherein the content comprises image content, and wherein the user interface comprises an image viewer.

48. A method of facilitating user access to content stored within a plurality of network devices, comprising:
publishing content stored within each network device via a respective contributor module associated with each network device;
aggregating meta information about content stored within each network device via an aggregator module in communication with each contributor module; and
presenting content to users via a user interface, wherein the user interface queries the aggregator module for content available on the network, displays results of the query, and, in response to user selection of displayed results, retrieves and presents content from one or more network devices.

49. The method of claim 48, wherein publishing content stored within each network device via a respective contributor module comprises:
monitoring content stored within a network device; and
announcing the presence of content stored within each network device to other network devices.

50. The method of claim 49, wherein monitoring content stored within each network device and announcing the presence of content stored within each network device is performed substantially continuously via each respective contributor module.

51. The method of claim 48, wherein aggregating meta information from each contributor module is performed substantially continuously via the aggregator module.

52. The method of claim 48, further comprising categorizing the content stored within the network devices into one or more content categories via a categorizer module in communication with the aggregator module.

53. The method of claim 48, further comprising tailoring requested content prior to retrieval by the user interface.

54. The method of claim 48, further comprising changing a format of requested content from a first format to a second format different from the first format prior to retrieval by the user interface.

55. The method of claim 48, further comprising retrieving content from the network devices and storing the retrieved content within the aggregator module.

56. The method of claim 48, further comprising granting external network access to content stored within the network devices to authorized users via a gateway connected to the network.

57. The method of claim 48, wherein the content comprises audio content, and wherein the user interface comprises an audio player.

58. The method of claim 48, wherein the content comprises video content, and wherein the user interface comprises a video player.

59. The method of claim 48, wherein the content comprises image content, and wherein the user interface comprises an image viewer.

60. A method of facilitating user access to content stored within a plurality of network devices, comprising:
publishing content stored within each network device substantially continuously via a respective contributor module associated with each network device;
aggregating meta information about content stored within each network device substantially continuously via an aggregator module in communication with each contributor module;
categorizing the content stored within the network devices into one or more content categories via a categorizer module in communication with the aggregator module; and
presenting content to users via a user interface, wherein the user interface queries the aggregator module for content available on the network, displays results of the query, and, in response to user selection of displayed results, retrieves and presents content from one or more network devices.

61. The method of claim 60, wherein publishing content stored within each network device via a respective contributor module comprises:
monitoring content stored within a network device; and
announcing the presence of content stored within each network device to other network devices.

62. The method of claim 60, further comprising tailoring requested content prior to retrieval by the user interface.

63. The method of claim 60, further comprising changing a format of requested content from a first format to a second format different from the first format prior to retrieval by the user interface.

64. The method of claim 60, further comprising retrieving content from the network devices and storing the retrieved content within the aggregator module.

65. The method of claim 60, further comprising granting external network access to content stored within the network devices to authorized users via a gateway connected to the network.

66. The method of claim 60, wherein the content comprises audio content, and wherein the user interface comprises an audio player.

67. The method of claim 60, wherein the content comprises video content, and wherein the user interface comprises a video player.

68. The method of claim 60, wherein the content comprises image content, and wherein the user interface comprises an image viewer.

69. A method of facilitating user access to audio content stored within a plurality of network devices, comprising:
publishing audio content stored within each network device via a respective contributor module associated with each network device;
aggregating meta information about audio content stored within each network device via an aggregator module in communication with each contributor module;
categorizing the audio content stored within the network devices into one or more audio content channels via a categorizer module in communication with the aggregator module; and
presenting audio content to users via a user interface in communication with the network, wherein the user interface comprises an audio player that retrieves and plays audio content from the network devices in response to user selection of a channel.

70. The method of claim 69, wherein publishing audio content stored within each network device via a respective contributor module comprises:
monitoring audio content stored within a network device; and
announcing the presence of audio content stored within each network device to other network devices.

71. The method of claim 70, wherein monitoring audio content stored within each network device and announcing the presence of audio content stored within each network device is performed substantially continuously via each respective contributor module.

72. The method of claim 69, wherein aggregating meta information from each contributor module is performed substantially continuously via the aggregator module.

73. The method of claim 69, further comprising tailoring requested audio content prior to retrieval by the user interface.

74. The method of claim 69, further comprising changing a format of requested audio content from a first format to a second format different from the first format prior to retrieval by the user interface.

75. The method of claim 69, further comprising retrieving audio content from the network devices and storing the retrieved audio content within the aggregator module.

76. The method of claim 69, further comprising granting external network access to audio content stored within the network devices to authorized users via a gateway connected to the network.

77. A method of facilitating user access to video content stored within a plurality of network devices, comprising:
publishing video content stored within each network device via a respective contributor module associated with each network device;
aggregating meta information about video content stored within each network device via an aggregator module in communication with each contributor module;
categorizing the video content stored within the network devices into one or more video content channels via a categorizer module in communication with the aggregator module; and
presenting video content to users via a user interface in communication with the network, wherein the user interface comprises a video player that retrieves and plays video content from the network devices in response to user selection of a channel.

78. The method of claim 77, wherein publishing video content stored within each network device via a respective contributor module comprises:
monitoring video content stored within a network device; and
announcing the presence of video content stored within each network device to other network devices.

79. The method of claim 78, wherein monitoring video content stored within each network device and announcing the presence of video content stored within each network device is performed substantially continuously via each respective contributor module.

80. The method of claim 77, wherein aggregating meta information from each contributor module is performed substantially continuously via the aggregator module.

81. The method of claim 77, further comprising tailoring requested video content prior to retrieval by the user interface.

82. The method of claim 77, further comprising changing a format of requested video content from a first format to a second format different from the first format prior to retrieval by the user interface.

83. The method of claim 77, further comprising retrieving video content from the network devices and storing the retrieved video content within the aggregator module.

84. The method of claim 77, further comprising granting external network access to video content stored within the network devices to authorized users via a gateway connected to the network.
